(19) United States
(12) Patent Application Publication
(10) Pub. No.: US 2005/0267277 A1
(43) Pub. Date: Dec. 1, 2005

(54) Composition for forming anti-reflective coating film, anti-reflective coating film composed of the composition, and method of forming resist pattern using the composition

(76) Inventors: Masaru Takahama, Kanagawa (JP); Yoshinori Sakamoto, Kanagawa (JP); Takeshi Tanaka, Kanagawa (JP); Naoki Yamashita, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/131,205

(22) Filed: May 18, 2005

(30) Foreign Application Priority Data
May 26, 2004 (JP) 2004-156333

(51) Int. Cl. C08G 77/26

(52) U.S. Cl. 528/38

(57) ABSTRACT

The composition for forming an anti-reflective coating film of the present invention has a hard-volatility and high coating performance. In particular, when the 193 nm ArF excimer laser beam source is applied, the composition exhibits a higher etching property. Therefore, the composition is suitably for forming an anti-reflective coating film with no voids and for a method of forming resist patterns using the composition. The composition for forming an anti-reflective coating film comprising; (A) a hard-volatility light absorbing compound, (B) siloxanepolymer, and (C) a solvent.

### BACKGROUND OF THE INVENTION

This application is based upon and claims the benefit of priority from Japanese Patent Application No. 2004-156333, filed May 26, 2004, the entire contents of which are incorporated herein by reference.

1. Field of the Invention

The present invention relates to a composition for forming an anti-reflective coating film, an anti-reflective coating film composed of the composition, and method of forming a resist pattern using the composition. In particular, the present invention relates to a composition for forming an anti-reflective coating film having properties of hard-volatility without accompanying volatile component during formation process for an anti-reflective coating film and of high coating performance; an anti-reflective coating film composed of the composition having high etching property and no void; and method of forming a resist pattern using the composition.

2. Description of the Related Art

In manufacturing microstructures of a wide variety of electronic devices such as a semiconductor device, a liquid crystal device and the like, lithography has been frequently used. Meanwhile, as device structures have been increasingly miniaturized, a need has arisen for further miniaturized resist patterns during the lithographic process.

In recent years, to address the need for this miniaturization, wavelengths of light beams used tend to become shorter. Generally, such shorter-wavelength light beams used are; a “g” line having a primary spectrum of 436 nm in a mercury lamp for approximately 0.5 μm of resist resolution; an “i” line having a primary spectrum of 365 nm in a mercury lamp for approximately 0.5 to 0.30 μm of resist resolution; and a KrF excimer laser beam having a primary spectrum of 248 nm for approximately 0.30 to 0.15 μm of resist solution. In addition, an ArF excimer laser beam having a primary spectrum of 193 nm is used for 0.15 μm or lower resist resolution.

According to such a shortening of the wavelength of light beams, it has been known that a light interference is caused during formation process for a resist pattern by exposing light beams to a resist layer. That is, the exposed light is transmitted through the resist layer, the transmitted light is reflected on the surface of an undercoating layer, and in turn a part of the reflected light is reflected on a top surface of the resist layer. Since such a phenomenon is repeated within a resist layer, a variation in thickness of photoresist will have an influence on sizes and widths of resist patterns obtained after development process. As a result, this will deteriorate dimensional accuracy of resist patterns. In order to dissolve the problem that resist formation is interfered by the reflected light beam caused by shortening wavelengths of light beams, an anti-reflective coating film has been used.

In recent years, a need has arisen to reduce the thickness of photoresist used by shortening wavelengths of light beams. Since any thin photoresist film has a lower etching resistance, it is required that an anti-reflective coating film be etched at a high etching rate. Further, since the anti-reflective coating film may be used as an under layer, it is required that the anti-reflective coating film be formed to fill via and spaces in sizes of 0.1 μm or smaller without accompanying any voids.

In order to solve the problem of the anti-reflective coating film, a patent document 1 (Japanese Patent Application Laid-open No. 2003-502449 A) discloses that, for example, a mixture of hydrogensilsesquioxane and an organic absorbing compound is used for an anti-reflective coating. In the disclosure, any of compounds such as phenylethoxysilane is used for the organic absorbing compound, and the organic absorbing compound is interposed into or reacted with siloxanepolymer, such as hydrogensilsesquioxane. In addition, the patent document 1 describes that the aforementioned phenylethoxysilane is reacted with siloxanepolymer to obtain a polymer.

Patent Document 1: JP NO. 2003-502449 A

As described in the aforementioned patent document 1, however, a problem occurred that, by only adding phenylethoxysilane to siloxanepolymer such as hydrogensilsesquioxane, no preferred film can be formed. Because the organic absorbing compound, for example, phenylethoxysilane valatilizes when heated after a coating solution of the mixture is coated on the resist film. Further, when the phenylethoxysilane is polymerized, a reflux or the like process is required during manufacturing the polymer because reaction rates of monomers differ from each other, thereby increasing manufacturing processes.

### SUMMARY OF THE INVENTION

Accordingly, an object of the present invention is to provide an easy-to-manufacture composition for forming an anti-reflective coating film without accompanying problems such that the coating solution volatilizes, which prevents a suitable film formation as mentioned above, and in particular, a composition for forming anti-reflective coating film having high coating performance and capable of suppressing any interference of the reflected light beam irradiated from ArF excimer laser beam source for 193 nm. In addition, an object of the present invention is to provide an anti-reflective coating film composed of the above-mentioned composition having high etching property and with no void, and a method of forming a resist pattern using the composition.

The inventers of the present invention have made an intensive study to make an attempt to solve the problems and found that the anti-reflective coating film having high etching property and with no void can be obtained by using a condensation polymer and/or a compound presumed to be hydrolyzed compound as a light absorbing compound, which is produced from an acid catalyst reaction of phenyltrialkoxysilane. Based on the finding mentioned above, the present invention can be successfully achieved.

Namely, the composition for forming anti-reflective coating film according to the present invention is characterized in that the composition comprises: (A) a hard-volatility light absorbing compound, (B) siloxanepolymer, and (C) a solvent.

The aforementioned (A) hard-volatility light absorbing compound is preferably a hydrolytic reaction product of phenylalkoxysilane, and a condensation polymer of phenylalkoxysilane, a hydrolyzed product of phenylalkoxysilane and a mixture of the condensation polymer of phenylalkoxysilane and the hydrolyzed product of phenylalkoxysilane may be used.

The aforementioned phenylalkoxysilane is preferably any of phenyltrialkoxysilanes such as phenyltrimethoxysilane and phenyltriethoxysilane.

The aforementioned solvent is preferably any of aprotic and hydrophilic solvents such as propyleneglycoldimethylether and propyleneglycolmonomethyletherasetate. The reaction time of the aforementioned hydrolysis reaction is preferably more than or equal to 20 hours and less than or equal to two weeks.

The aforementioned (B) siloxanepolymer in the composition for forming an anti-reflective coating film of the present invention is preferably hydrogensilsesquioxane. The ratio of the aforementioned components (A) and (B) in the composition for forming an anti-reflective coating film of the present invention preferably falls between 30:70 and 5:95. The aforementioned (C) solvent preferably contains any of high-boiling point solvents such as propyleneglycolmonomethyletheracetate.

The anti-reflective coating film of the present invention is characterized in that it is capable of reducing any interference within a resist film layer and is prepared by using the composition for forming an anti-reflective coating film as mentioned above.

A method of forming a resist pattern of the present invention is characterized in that the method comprises the steps of; forming an undercoating layer on a substrate using the aforementioned composition for forming an anti-reflective coating film; forming a resist film on the undercoating layer; selectively irradiating a light beam onto the resist film; heating the resist film, if necessary; and developing the resist film after being irradiated by the light beam, thereby obtaining resist patterns.

The composition for forming anti-reflective coating film according to the present invention has a hard-volatility and high coating performance. In addition, the present invention provides the anti-reflective coating film composed of the composition having a high etching property and with no void, especially, when the 193 nm ArF excimer laser beam source being used. Further, the present invention provides a method of forming resist patterns using the composition.

### DETAILED DESCRIPTION OF THE PREFERRED EMBODIMENTS

A composition for forming anti-reflective coating film according to the present invention comprises (A) hard-volatility light absorbing compound, (B) siloxanepolymer, and (C) solvent.

By using the hard-volatility component (A) as a light absorbing compound, an anti-reflective coating film can easily be prepared and a suitable anti-reflective coating film can be formed. Because the light absorbing compound may be prevented from volatilizing during the heating step after coating solution of the compound for forming an anti-reflective coating film is applied on a resist film. The resulting anti-reflective coating film has a high etching property and with no void. By using the anti-reflective coating film, fine resist patterns can be formed. The hard-volatility light absorbing compound has a light absorbing band of approximately lower than or equal to 200 nm corresponding to the light beam irradiated from the 193 nm ArF excimer laser beam source and in particular, has preferably a light absorbing peak falling between 185 and 200 nm.

The aforementioned (A) hard-volatility light absorbing compound is preferably a hydrolytic reaction product of phenylalkoxysilane. It may be considered that among the hydrolytic reaction products of phenylalkoxysilane, a condensation polymer of phenylalkoxysilane, a hydrolytic reaction product of phenylalkoxysilane, and a mixture of the condensation polymer of phenylalkoxysilane and the hydrolytic reaction product of phenylalkoxysilane fulfill function of the aforementioned (A) hard-volatility light absorbing compound.

Although phenyltrialkoxysilane itself inevitably volatilizes when heated during the resist pattern formation process, a suitable anti-reflective coating film can be formed because the hydrolytic reaction product of phenyltrialkoxysilane mentioned above accompanies no volatilization by heating due to its hard-volatile property and the anti-reflecting property of the hydrolytic reaction product is not changed.

The aforementioned phenyltrialkoxysilane may include various types of phenyltrialkoxysilanes with no limitation. Among these phenyltrialkoxysilanes, those with a smaller alkoxy group, such as phenytrimethoxysilane and phenytriethoxysilane, has higher reactivity, thereby promoting the hydrolytic reaction and condensation polymerization. Therefore, it is preferable to select at least one of phenytrimethoxysilane and phenytriethoxysilane for phenyltrialkoxysilane.

The aforementioned hydrolytic reaction of phenylalkoxysilane proceeds by adding water to an organic solvent solution of the phenylalkoxysilane under the presence of an acid catalyst. For the acid catalyst, any of conventionally used organic acids and inorganic acids may be used. The organic acids include, for example, organic carboxylic acids such as acetic acid, propionic acid and butyric acid. The inorganic acids include, for example, mineral acids such as hydrochloric acid, nitric acid, sulfuric acid and phosphoric acid. Among them, nitric acid is preferable because of its industrial availability with ease and low cost.

Namely, it is preferable that the aforementioned hydrolytic reaction takes place in the solvent containing water and nitric acid aqueous solution. The hydrolytic reaction products obtained in this way may have suitable effects for (A) hard-volatility light absorbing compound in the composition for forming anti-reflective coating film of the present invention.

The amount of acid catalyst used is prepared so that its concentration in the aforementioned hydrolytic system may fall between 100 and 10000 ppm, preferably 100 to 1000 ppm. In the case of a less amount of acid catalyst, the hydrolytic reaction proceeds insufficiently, while in the case of an excess amount, the reaction solution tends to change with time considerably, both cases being not preferable. At this point, in the hydrolytic treatment, the alkoxysilane compound may be perfectly hydrolyzed or may be partially hydrolyzed. The degree of hydrolysis, namely the hydrolytic level may be regulated by means of adjusting the amount of water added. It is preferable that the amount of water added is prepared so that it is 0.5 to 1.5 mol times to the total mol value of the alkoxy group (Si—OR group) of a silica material (phenyltrialkoxysilane) in the reaction system. In the case of a less amount of water, a temporal storing stability of the finally produced composition for forming an anti-reflective coating film is high but the hydrolytic level is low and many organic groups being left in the hydrolyzed product. For this reason, it is not preferable that a coating film is formed using this composition because a gas generated from the decomposed organic component is noticeable amount. In contrast to this, it is not preferable that an excessive amount of water is added in manufacturing the composition because the can-stability of the produced composition deteriorates.

For the aforementioned solvent, various types of organic solvents that are conventionally and commonly used may be utilized with no limitation. Specifically, these solvents include monohydric alcohols such as methyl alcohol, ethyl alcohol, propyl alcohol and butyl alcohol; alkylcarboxylate esters such as metyl-3-methoxypropionate and etyl-3-ethoxypropionate; polyhydric alcohols such as ethylene glycol, diethylene glycol and propyleneglycol; polyhydric alcohol derivatives such as ethylene glycolmonomethylether, ethylene glycolmonoethylether, ethylene glycolmonopropylether, ethylene glycolmonobutylether, propylene glycolmonomethylether, propylene glycolmonoethylether, propylene glycolmonopropylether, propylene glycolmonobutylether, ethylene glycolmonomethyletheracetate, ethylene glycolmonoethyletheracetate, propylene glycolmonomethyletheracetate and propylene glycolmonoethyletheracetate; fatty acids such as acetic acid and propionic acid; and ketones such as acetone, methyl ethyl ketone, and 2-heptanone. These organic solvents may be used alone, or a combination of two or more of these solvents may be used. Among these solvents, an aprotic and hydrophilic solvent is preferable and in particular, for example, propylene glycoldimethylether (hereinafter, abbreviated as “PGDM”) and propylene glycolmonomethyletheracetate (hereinafter, abbreviated as “PGMEA”) is more preferable.

The reaction time of acid catalyst reaction using nitric acid is preferably more than or equal to 10 hours and more preferably, more than or equal to 20 hours and less than or equal to two weeks.

The aforementioned (B) siloxanepolymer in the composition for forming an anti-reflective coating film of the present invention may include various types of siloxanepolymer with no limitation. This siloxanepolymer may include, for example, methylsiloxane, methylsilsesquioxane, phenylsiloxane, and methylphenylsilsesquioxane. Among them, hydrogensilsesquioxane is preferable, because which promotes an etching rate.

For the aforementioned hydrogensilsesquioxane, any commercially available product may be used. This type of hydrogensilsesquioxane is preferably OCD T-12 (Product name; made by Tokyo Ohka Kogyo Co., Ltd.), which is a coating solution containing the hydrolyzed product of trialkoxysilane.

The ratio of the aforementioned components (A) and (B) in the composition for forming an anti-reflecting film of the present invention is preferably 30:70 to 5:95, more preferably 10:90 to 20:80. The increased ratio of phenylalkoxysilane deteriorates the filling performance of a resist film, resulting in decreasing etching rate. On the other hand, the decreased ratio of phenylalkoxysilane deteriorates an absorbing ability of the reflected light.

The aforementioned (C) solvent in the composition for forming an anti-reflective coating film of the present invention is preferably a high boiling-point solvent. The use of the high boiling-point solvent allows for high quality films, preventing fine voids from being produced. This high boiling-point solvent is any of solvents, of which boiling points fall between 100 and 300° C. Typical examples of this type of solvents are exemplified below. The organic solvents with boiling points falling between 100 and 150° C. include ligroin, methylcyclohexane, dioxane, acetal, trichlorobromomethane, isobutanol, sec-butyl acetate, toluene, 1,1,2-trichloroethane, pyridine, methylisobutylketone, n-butanol, isobutylacetate, acetic acid, propyleneglycolmonomethylether, 2-nitropropane, perchloroethylene, methylcellosolve, n-octane, n-butyl acetate, morpholine, amyl acetate, mesityl oxide, 4-metyl-2-pentanol, 1-nitropropane, ethylcyclohexane, chlorobenzene, cellosolve, methylisoamylketone, ethylbenzene, xylene, n-amyl alcohol, acetic anhydride, methylamylketone, dibutylether, isoamylacetate, ethyl-n-butylketone, ethyleneglycolmonoisopropylether, metyllactate, methylcellosolveacetate, isobutylisobutylate and n-amyl acetate.

The organic solvents, of which boiling points fall between 150 and 200° C., include n-nonan, cumene, dimethylformamide, anisole, methyl lactate, cyclohexanone, ethylamylketone, cellosolveacetate, 4-methoxy-4-methylpentanone-2,1-hexanol, methoxybutanol, cyclohexanol, furfural, pentachloroethane, ethyleneglycolmonoisopropyletheracetate, diacetone alcohol, methylcyclohexanone, furfuryl alcohol, methoxybutylacetate, butylcellosolve, 3-methyl-3-methoxybutanol, n-decane, cyclohexylacetate, methylcarbamate, dichloroethyl ether, tetrahydrofurfuryl alcohol, o-dichlorobenzene, propyleneglycolmonobutylether, propyleneglycolmonopropylether, ethyl acetoacetate, Swasol 1500, carbolic acid, 2-ethylhexanol, aniline, propyleneglycol, diethyleneglycoldiethyleter, dimethylsulfoxide, ethyleneglycoldiacetate, benzonitrile, decalin, butylcellosolveacetate, dimethylaniline, methylcarbitol, 1-octanol, pineoil, ethyleneglycol, 2-ethylhexylacetate, methylbenzoate and hexyleneglycol.

In addition, the organic solvents, of which boiling points fall between 200 and 300° C., include Swasol 1800, acetophenone, carbitol, N-methyl-2-pyrrolidone, ethyleneglycoldibutylether, phenylmethylcarbinol, benzylalcohol, tetralin, 1,3-butyleneglycol, nitrobenzene, terpineol, isophorone, methylbenzylalcohol, carbitolacetate, acetamide, methylsalicylate, butylcarbitol, quinoline, diethyleneglycol, diethyleneglycolmonobutyletheracetate, diethyleneglycoldi-n-butylether, triethyleneglycolmonoethylether and triacetin.

Among them, propyleneglycolmonomethyletheracetate is preferable. This high boiling-point solvent may be used alone or may be used by mixing with any other solvent.

Moreover, the aforementioned composition for forming an anti-reflective coating film may contain, for example, a surfactant for improving the coating performance of the composition and an acid for promoting dehydration condensation in the burning process as arbitrary components, if applicable.

The anti-reflective coating film according to the present invention is characterized in that the anti-reflective coating film is formed by using the aforementioned composition for forming an anti-reflective coating film mentioned above, and reduces any interference in a resist film caused by exposing light beam. The anti-reflective coating film may be formed by; applying the aforementioned composition for forming an anti-reflective coating film on a silicone wafer using any of techniques such as a spin coating method; heating the composition on a hot plate in the atmosphere; drying the composition at a temperature between 150 to 200° C.; and heating (burning) the composition in an atmosphere of nitrogen.

A method of forming a resist pattern according to the present invention is characterized in that it comprises the steps of; forming an undercoating layer on a substrate using the aforementioned composition for forming an anti-reflective coating film; forming a resist film on the undercoating layer; selectively irradiating a light beam onto the resist film; heating the resist, if necessary; and developing the resist film after being irradiated by the light beam, thereby obtaining resist patterns.

For the resist film, on which the anti-reflective coating film of the present invention is provided, any of usually used ones may be selected with no limitation. Either a positive type or a negative type resist film may be used and in particular, a resist film, which is composed of a photo-sensitive material and a film forming material and may be developed with an alkali aqueous solution, is preferably used.

Especially favorable resist is both positive types and negative type photoresist films which have properties sufficiently suitable for the recent hyperfine processes. The positive photoresist films include those composed of the composition containing a quinonediazide photosensitive material and a film forming substance.

Positive type of other resist films include chemically amplifying resist films, wherein alkali solubility of which is amplified by a catalytic function of acid generated by an exposure of light beam.

The negative type photoresist films are not limited to specific ones and those conventionally known to as negative type photoresist films may be used. The negative type of chemically amplifying resist films containing three components, a cross-linking agent, acid-generating agent and a base polymer, which are used in forming fine patterns as the negative type photoresist films, is in particular preferable.

Now, one example of the method of preparing an anti-reflective coating film and of forming the resist patterns of the present invention is given. First, an undercoating layer is formed by coating the composition for forming an anti-reflective coating film on a substrate, for example, a silicone wafer by any of methods such as a spinner method. A photoresist film is then coated onto the undercoating layer by any of methods such as a spinner method. The photoresist film is then formed by an application of heat treatment. Note that the heating treatment is not necessarily required and may be eliminated if the suitable coating film with high uniformity is achieved by only coating the compound.

For the aforementioned coating method, in addition to the spinner method, any of known methods may be used including roll coater, immersion and updraw coating, spraying, screen printing, and brushing, if applicable.

Further, an active light beam, for example, UV or far UV (including an excimer laser) is selectively irradiated onto the photoresist film through the anti-reflective coating film using lithography. After heating the substrate, if necessary, the photoresist film is developed to form resist patterns on the wafer.

Now, referring to examples of the present invention, the present invention is described in detail below. Note that it is not intended to limit the present invention to the examples described below.

### EXAMPLE 1

198.0 g of phenyltrimethoxysilane, 94.2 g of PGDM, 107.8 g of water, and 14.5 μl of 60% nitric acid aqueous solution were mixed and stirred. After one week aging, solvent substitution was applied to the mixture in an evaporator for removing methanol and water contents to obtain 210 g of solution. 290 g of PGDM was further added in the solution.

7.0 g of the aforementioned solution, 39.7 g of OCD T-12 (product name: made by Tokyo Ohka Kogyo Co., Ltd.), which is a coating solution containing a hydrolyzed product of trialkoxysilane, and 33.3 g of PGMEA were mixed and stirred to obtain the composition for forming an anti-reflective coating film.

According to a method of forming an anti-reflective coating film described below, the anti-reflective coating film was formed and its absorption at a wavelength of 193 nm, the presence of voids, and its etching rate were evaluated. The result was shown in Table 1. As shown in Table 1, the results of evaluation of its absorbance, the presence of voids, and its etching rate were highly preferable.

### EXAMPLE 2

48.0 g of phenytriethoxysilane, 10.4 g of PGMEA, 21.6 g of water, and 14.5 μl of 60% nitric acid aqueous solution were mixed and stirred. After 24 hour-stirring, solvent substitution was applied to the mixture in an evaporator for removing ethanol and water contents to obtain 48 g of solution. 100 g of PGMEA was further added in the solution.

5.0 g of the aforementioned solution, 12.8 g of OCD T-12 (product name: made by Tokyo Ohka Kogyo Co., Ltd.), which is a coating solution containing a hydrolyzed product of trialkoxysilane, and 14.9 g of PGMEA were mixed and stirred to obtain the composition for forming an anti-reflective coating film.

According to a method of forming an anti-reflective coating film described below, the anti-reflective coating film was formed and its absorption at a wavelength of 193 nm, the presence of voids, and its etching rate were evaluated. The result was shown in Table 1. As shown in Table 1, the results of evaluation of its absorbance, the presence of voids, and its etching rate were highly preferable.

### COMPARATIVE EXAMPLE 1

95.5 g of phenyltriethoxysilane, 20.6 g of PGDM, 43.1 g of water, and 290 μl of 60% nitric acid aqueous solution were mixed and stirred. After 24 hour-stirring, solvent substitution was applied to the mixture in an evaporator for removing ethanol and water contents to obtain 81.0 g of solution. PGDM was further added in the solution to obtain 200 g of solution and then achieved a coating compound.

According to a method of forming an anti-reflective coating film described below, the anti-reflected film was formed. An occurrence of striation prevented the suitable film from being formed.

### COMPARATIVE EXAMPLE 2

7.2 g of phenyltriethoxysilane and 12.8 g of OCD T-12 (Product name: made by Tokyo Ohka Kogyo Co., Ltd.), which is a coating solution containing a hydrolyzed product of trialkoxysilane, were mixed and stirred for three hours to obtain a composition for coating.

According to a method of forming an anti-reflective coating film described below, the anti-reflected film was formed. An occurrence of striation prevented the suitable film from being formed.

### COMPARATIVE EXAMPLE 3

OCD T-12 (Product name: made by Tokyo Ohka Kogyo Co., Ltd.), which is a coating solution containing a hydrolyzed product of trialkoxysilane, was used for a composition for coating.

According to a method of forming an anti-reflective coating film described below, the anti-reflective coating film was formed and its absorption at a wavelength of 193 nm, the presence of voids, and its etching rate were evaluated. The result was shown in Table 1. As shown in Table 1, the results demonstrated that the absorbance of the resulting anti-reflective coating film was 0, indicating that it is not suitable for the anti-reflective coating film. Method of forming an anti-reflective coating film

A composition for coating was applied onto a silicone wafer with a 0.1 μm line and space (L&S) formed thereon by the spin coating method followed by being heated on the hot plate at 80° C. in an atmosphere for one minute. Then, it was further heated at 150° C. for one minute and then 200° C. for one minute (drying step) to form a 350 nm thickness of coating film was achieved.

Method of Evaluating an Anti-Reflective Coating Film

An absorbance of the formed film was measured at the wavelength of 193 nm by spectroscopic ellipsometry.

Evaluation of the Presence of Voids

A presence of voids was observed in a 1 μm of space under a cross-sectional SEM. Films with no void were marked “Good” and those with voids were marked “NG”.

Evaluation of Etching Rate

A dry etching treatment was applied to the coating films obtained in the aforementioned Examples 1 and 2, and Comparative example 3 to evaluate their etching rates.

Note that the dry etching treatment was performed under the treatment conditions described below.

Treatment conditions: Using oxide film etcher (Product name “TCE7612-XX”; Tokyo Ohka Kogyo Co., Ltd.), dry etching was evaluated under the conditions; 400 W of output, pressure of 300 mTorr, and the etching composition CF₄/CHF₃/He=25/25/100 (cc/min) for 30 seconds.

TABLE 1

| | | Evaluation of | Etching Rate |
|---|---|---|---|
| | Absorption | Voids | (Angstrom/min) |
| Example 1 | 0.24 | Good | 2029 |
| Example 2 | 0.375 | Good | 1545 |
| Comparative | — | — | — |
| Example 1 | | | |
| Comparative | — | — | — |
| Example 2 | | | |
| Comparative | 0 | Good | 3220 |
| Example 3 | | | |

As understood from the descriptions above, the composition for forming an anti-reflective coating film of the present invention has a hard-volatility and high coating performance. In particular, when the 193 nm ArF excimer laser beam source is applied, the composition exhibits a higher etching property. Therefore, the composition is suitably for forming an anti-reflective coating film with no voids and for a method of forming resist patterns using the composition.

1. A composition for forming an anti-reflective coating film comprising:
(A) a hard-volatility light absorbing compound;
(B) siloxanepolymer; and
(C) a solvent.

2. The composition for forming an anti-reflective coating film according to claim 1, wherein the (A) hard-volatility light absorbing compound is a hydrolyzed product and/or a partial condensation polymer of phenylalkoxysilane.

3. The composition for forming an anti-reflective coating film according to claim 2, wherein the phenylalkoxysilane is phenyltrilalkoxysilane.

4. The composition for forming an anti-reflective coating film according to claim 3, wherein the phenyltrilalkoxysilane is at least one of phenyltrimethoxysilane and phenyltriethoxysilane.

5. The composition for forming an anti-reflective coating film according to claim 1, wherein the (C) solvent is an aprotic hydrophilic solvent.

6. The composition for forming an anti-reflective coating film according to claim 5, wherein the aprotic hydrophilic solvent is propyleneglycoldimethylether or propyleneglycolmonomethyletheracetate.

7. The composition for anti-reflective coating film according to claim 1, wherein the (B) siloxanepolymer is hydrogensilsesquioxane.

8. The composition for forming an anti-reflective coating film according to claim 1, wherein a ratio of the components (A) and (B) falls between 30:70 and 5:95.

9. The composition for forming an anti-reflective coating film according to claim 1, wherein the (C) solvent contains at least a high boiling-point solvent.

10. The composition for forming an anti-reflective coating film according to claim 9, wherein the high boiling-point solvent is propyleneglycolmonomethyletheracetate.

11. An anti-reflective coating film for reducing a light interference in a resist layer caused by an exposure of light beams, wherein the anti-reflective coating film is prepared by a composition comprising:
(A) a hard-volatility light absorbing compound;
(B) siloxanepolymer; and
(C) a solvent.

12. A method of forming a resist pattern comprising the steps of:
forming an undercoating layer on a substrate using a composition comprising,
(A) a hard-volatility light absorbing compound,
(B) siloxanepolymer, and
(C) a solvent;
forming a resist film on the undercoating layer;
irradiating a light beam selectively onto the resist film; and
developing the resist film after a light beam is irradiated, thereby obtaining resist patterns.

13. The method of forming a resist patters according to claim 12, further comprising a step of heating the resist film formed on the undercoating layer.
